(19) United States
(12) Patent Application Publication
(10) Pub. No.: US 2016/0258844 A1
(43) Pub. Date: Sep. 8, 2016

(54) MONITORING OPERATION OF A REACTION CHAMBER

(71) Applicant: INFICON, INC., East Syracuse, NY (US)

(72) Inventors: William Tuttle Conner, Newton, MA (US); Igor Tepermeister, Newton, MA (US)

(21) Appl. No.: 15/061,414

(22) Filed: Mar. 4, 2016

Related U.S. Application Data
(60) Provisional application No. 62/129,402, filed on Mar. 6, 2015.

(51) Int. Cl. G01M 99/00

(52) U.S. Cl. CPC G01M 99/005

(57) ABSTRACT

A method and system for monitoring operation of a reaction chamber for operation malfunctions. The reaction chamber includes a pressure gauge coupled therewith to collect pressure data within the reaction chamber during operation of the reaction chamber. The pressure data is received in a processor and a plurality of pressure readings are generated from the pressure data, identifying pressure changes within the reaction chamber during operation. The plurality of pressure readings are analyzed to identify an abnormal pressure change and an operating malfunction is determined when the abnormal pressure change is identified.

### CROSS-REFERENCE TO RELATED APPLICATIONS

This application claims the benefit and priority of U.S. Patent Application Ser. No. 62/129,402, filed Mar. 6, 2015 and entitled MONITORING OPERATION OF A REACTION CHAMBER, the entirety of which is incorporated herein by reference.

### BACKGROUND OF THE INVENTION

The subject matter disclosed herein relates to thin film production and, in particular, monitoring operation of thin film fabrication systems.

As technology has continued to evolve, use of thin films has become increasingly important. Thin films have been used in a variety of fields ranging from the electronics industry, such as in semiconductors and for computer memories, to pharmaceuticals for thin film drug delivery. As thin film popularity has increased, methods of fabricating thin films have been developed. Examples of these processes include deposition methods, such as atomic layer deposition, and etch methods, such as atomic layer etch.

In exemplary etch and deposition techniques, a substrate is placed in a reaction chamber and a succession of gases are released into the chamber to react with a surface of the substrate. The entire process chamber for these techniques is subjected to quick pressure changes due to rapid valve open/close cycles, which open/close cycles increase the wear of the hardware components and may cause a component to malfunction. Currently, to identify malfunctioning hardware in a varying pressure environment, the completed thin film is analyzed. If the thickness and/or composition of the thin film is not accurate, the hardware is identified as malfunctioning. However, due to time and cost constraints, not every sample can be tested, resulting in malfunctions not being identified immediately. Because of this delay, large numbers of defective samples can be produced, resulting in high costs.

The discussion above is merely provided for general background information and is not intended to be used as an aid in determining the scope of the claimed subject matter.

### BRIEF DESCRIPTION OF THE INVENTION

A method and system for monitoring operation of a reaction chamber for operation malfunctions are described herein. The reaction chamber includes a pressure gauge coupled therewith to collect pressure data within the reaction chamber during operation of the reaction chamber. The pressure data is received in a processor and a plurality of pressure readings are generated from the pressure data, identifying pressure changes within the reaction chamber during operation. The plurality of pressure readings are analyzed to identify an abnormal pressure change and an operating malfunction is determined when the abnormal pressure change is identified.

In one embodiment of the invention, a device for monitoring valve function is described. The device includes a reaction chamber for receiving a substrate and a plurality of gas inlets for introducing a plurality of gases to the reaction chamber. The device also includes a plurality of valves, a valve coupled to each gas inlet to control flow of gas through each gas inlet to the reaction chamber and a high-speed pressure gauge coupled to the reaction chamber to monitor pressure within the reaction chamber. A processor is coupled to the pressure gauge and configured to receive pressure data from the pressure gauge and generate a plurality of pressure readings to identify pressure changes within the reaction chamber due to operation of the plurality of valves. The processor compares the generated pressure readings to a reference pressure reading and analyzes the generated plurality of pressure readings to identify a change in pressure that differs from the reference pressure reading. The processor is further configured to identify which valve was operating during the change in pressure and diagnose the identified valve as a malfunctioning valve.

In another embodiment of the invention, a method for monitoring operation of a reaction chamber for malfunctions is described. The reaction chamber includes a high-speed pressure gauge coupled therewith to collect pressure data within the reaction chamber during operation of the reaction chamber. The method includes receiving, in a processor, the pressure data from the pressure gauge. A plurality of pressure readings is generated from the pressure data, identifying pressure changes within the reaction chamber during operation. The plurality of pressure readings is analyzed to identify an abnormal pressure change and an operating malfunction is determined when the abnormal pressure change is identified.

In another embodiment of the invention, a tangible, non-transitory, computer-readable storage medium including instructions to direct a processor to monitor operation of a reaction chamber for malfunctions is described herein. The reaction chamber includes a high-speed pressure gauge coupled therewith to collect pressure data within the reaction chamber during operation of the reaction chamber. The instructions direct the processor to receive the pressure data from the pressure gauge and generate a plurality of pressure readings from the pressure data identifying pressure changes within the reaction chamber during operation. The instructions further direct the processor to analyze the plurality of pressure readings to identify an abnormal pressure change and determine an operating malfunction when the abnormal pressure change is identified.

This brief description of the invention is intended only to provide a brief overview of subject matter disclosed herein according to one or more illustrative embodiments, and does not serve as a guide to interpreting the claims or to define or limit the scope of the invention, which is defined only by the appended claims. This brief description is provided to introduce an illustrative selection of concepts in a simplified form that are further described below in the detailed description. This brief description is not intended to identify key features or essential features of the claimed subject matter, nor is it intended to be used as an aid in determining the scope of the claimed subject matter. The claimed subject matter is not limited to implementations that solve any or all disadvantages noted in the background.

### BRIEF DESCRIPTION OF THE DRAWINGS

So that the manner in which the features of the invention can be understood, a detailed description of the invention may be had by reference to certain embodiments, some of which are illustrated in the accompanying drawings. It is to be noted, however, that the drawings illustrate only certain embodiments of this invention and are therefore not to be considered limiting of its scope, for the scope of the invention encompasses other equally effective embodiments. The drawings are not necessarily to scale, emphasis generally being placed upon illustrating the features of certain embodiments of the invention. Thus, for further understanding of the invention, reference can be made to the following detailed description, read in connection with the drawings in which:

FIG. 1 illustrates an exemplary monitoring system in accordance with an embodiment;

FIG. 2 is an exemplary pressure waveform diagram of normal operation of a system;

FIG. 2A is an enlarged view of a portion of the exemplary pressure waveform of FIG. 2;

FIG. 3 is a flow diagram for an exemplary method of analyzing a pressure waveform diagram;

FIG. 4 is an exemplary pressure waveform diagram of abnormal operation of a system;

FIG. 5 is a flow diagram for an exemplary method of analyzing a pressure waveform diagram of abnormal operation of a system;

FIG. 6 is another exemplary pressure waveform diagram of abnormal operation of a system;

FIG. 7 is a flow diagram for another exemplary method of analyzing a pressure waveform diagram of abnormal operation of a system;

FIG. 8 is another exemplary pressure waveform diagram of abnormal operation of a system;

FIG. 9 is a flow diagram for another exemplary method of analyzing a pressure waveform diagram of abnormal operation of a system; and

FIG. 10 is a flow diagram for an exemplary method of monitoring operation of a reaction chamber.

### DETAILED DESCRIPTION OF THE INVENTION

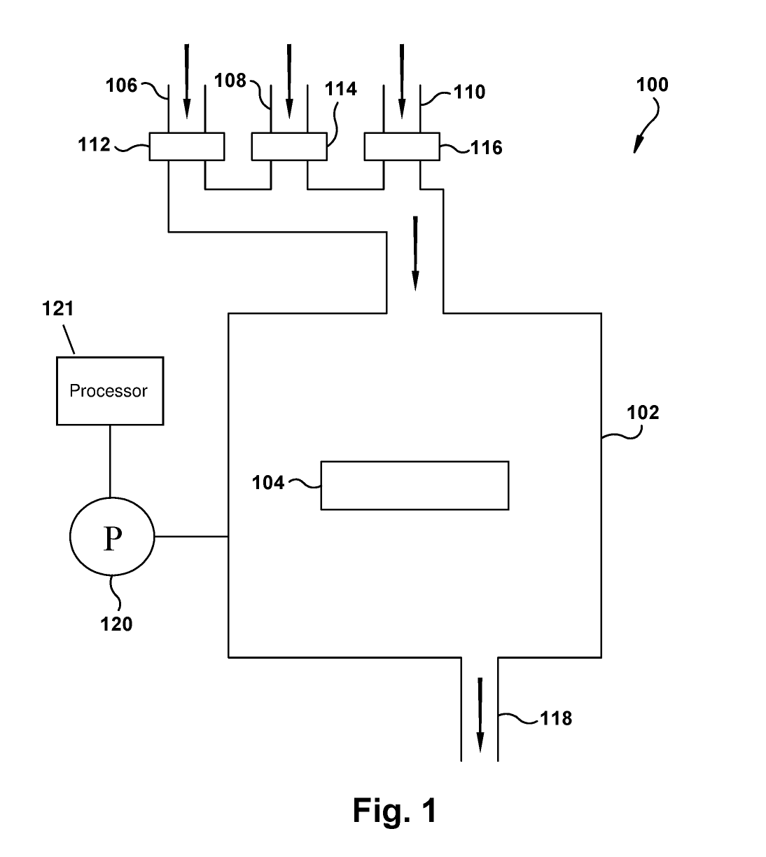

FIG. 1 illustrates an exemplary monitoring system 100 in accordance with an embodiment. The system 100 includes a reaction chamber 102 in which a substrate 104 is received. The reaction chamber 102 can be a chamber in which any suitable type of process is carried out. For example, the reaction chamber 102 can be a chamber in which pulse etching is performed on the substrate 104. In another example, the reaction chamber 102 can be a chamber in which the substrate 104 is coated.

In an embodiment, the reaction chamber 102 is an atomic layer deposition (ALD) chamber. ALD is a coating method in which a coating is deposited onto a flat surface to a specific thickness, to a molecular level, and having a specific stoichiometry. ALD is at least a two part process in which a portion of each molecular layer is deposited in each part.

In this embodiment, a plurality of gas inlets 106, 108, 110 direct the flow of the various gases into the reaction chamber 102 while a pumping system outlet 118 allows the gases to be removed from the reaction chamber 102. While three gas inlets are illustrated here, the number of gas inlets depends on the design of the reaction and the number of gases to be added to the reaction chamber 102. As illustrated here, the gas inlets 106, 108, 110 can be combined into a single inlet before entering the chamber. However, other designs, where the gas inlets 106, 108, 110 remain individual, are also possible. Each gas inlet 106, 108, 110 includes a valve 112, 114, 116 to regulate the flow of gases through the gas inlets 106, 108, 110 into the reaction chamber 102. A mass flow controller (not shown) can be coupled to each gas inlet 106, 108, 110 to control the flow rate of each gas. Opening and closing of the valves 112, 114, 116 occurs quickly and results in sudden large changes in pressure in the reaction chamber 102. Each reactant gas valve is kept open only long enough for a monolayer of the reactant to be deposited on the surface of the substrate. Keeping the valve open longer wastes both time and gas. The amount of time each valve is opened and closed ranges from less than 0.1 seconds to a few seconds or more, depending on the design of the process. Typically, only one valve is open at once and all valves are closed in between each valve being open, but other valve sequences are possible. A pressure monitor P 120 monitors the pressure within the reaction chamber 102 during operation. The pressure monitor P 120 is a high-speed pressure monitor, gathering pressure data from 10 to 1000 or more times per second.

In an exemplary ALD process, an aluminum oxide (Al₂O₃) coating is deposited on the substrate 104. To deposit this coating, a first valve 112 of a first gas inlet 106 is opened and a first gas including Aluminum, such as trimethylaluminum (TMA) Al(CH₃)₃ flows into the reaction chamber 102. When the first gas contacts the substrate 104, a monolayer of reactant is deposited on the surface of the substrate 104. When the desired time has been reached, the first valve 112 is closed and the first gas is removed from the reaction chamber 102 via the pumping system outlet 118. In an example, the first valve 112 is open for 0.2 seconds.

A second valve 114 (purge valve) of the second gas inlet 108 is opened, releasing a purge gas through the second gas inlet 108 into the reaction chamber 102. The purge gas is typically a gas that does not react with the other gases and is intended to remove any traces of the first gas that may remain in the reaction chamber 102, preventing the remaining first gas from reacting to the second gas upon release of the second gas into the reaction chamber 102. The second valve 114 is closed and the purge gas is removed from the reaction chamber via the pumping system outlet 118. In an example, the second valve 114 is open for 0.1 seconds.

Following removal of the purge gas, the third valve 116 is opened and a second gas, such as Oxygen gas O₂ is released into the chamber 102 via the third gas inlet 110. The Oxygen gas deposits the second half of the coating layer on the substrate surface, resulting in a single molecular layer of aluminum oxide. In an example, the third valve 116 is open for 0.3 seconds. After deposition, the third valve 116 is closed and the third gas is removed from the reaction chamber 102 via the pumping system outlet 118. The purge gas can be introduced to the system before and/or after each of the first gas and the second gas is introduced and removed. The deposition cycle can be repeated until the desired coating thickness is reached, which may require only a few cycles or hundreds or thousands of cycles, depending on the desired thickness.

The quick opening and closing of the valves 112, 114, 116 results in sudden large changes in pressure in the reaction chamber 102. These changes in pressure are monitored by a high-speed pressure monitor P 120 coupled to the reaction chamber 102. The pressure monitor P 120 can collect the pressure data at a high rate. For example, the pressure monitor P 120 can collect pressure data recordings 1000 times per second. The pressure data collected by the pressure monitor 120 can be transmitted to a processor 121. The processor 121 can analyze the pressure data to generate a plurality of pressure readings. In an embodiment, these pressure readings can be in the form of a pressure data waveform. Each pulse in the waveform corresponds to hardware operation, for example, referring to the valves, opening and closing of a valve. The waveform is analyzed to determine the size and shape of each pulse and other characteristics of the waveform. This information is then compared to the characteristics of a waveform recorded during known normal operation to determine if operation of the valve, or any other type of hardware being analyzed, is abnormal.

The frequent opening and closing of the valves causes them to wear quickly. When the valves begin to wear, the valves can malfunction in a variety of ways. Examples of valve malfunctions include the valve failing to open and/or close quickly enough, the valve failing to open and/or close fully, the valve failing to open at all, and a valve opening out of order, among others. By monitoring the pressure in the reaction chamber 102, hardware malfunctions, such as valve malfunctions, can be identified. For example, malfunctions related to gas delivery hardware, such as mass flow controller malfunctions and outward pumping system malfunctions, are identifiable as described herein. Incorrect valve sequencing can also be identified, whether it is due to malfunction or to improper design of the valve sequence controller.

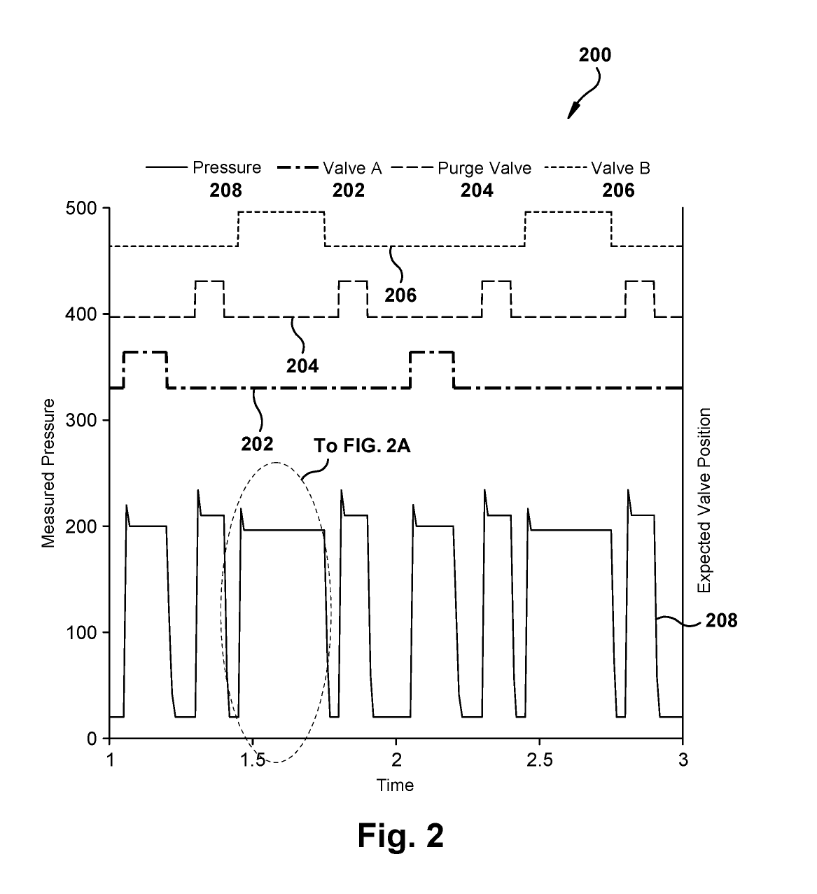

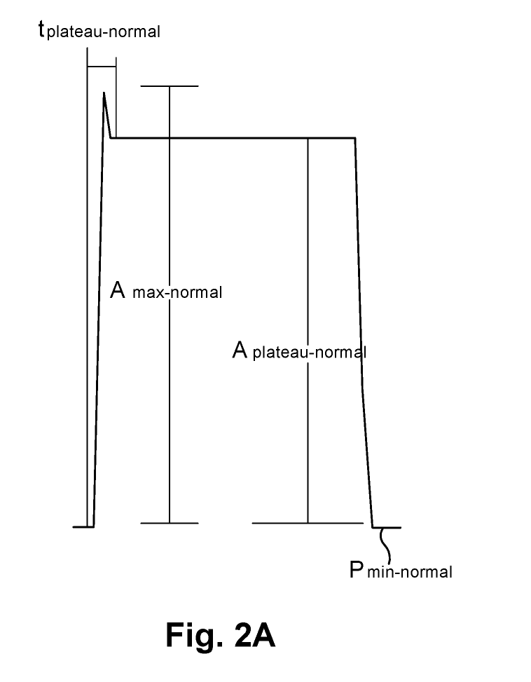

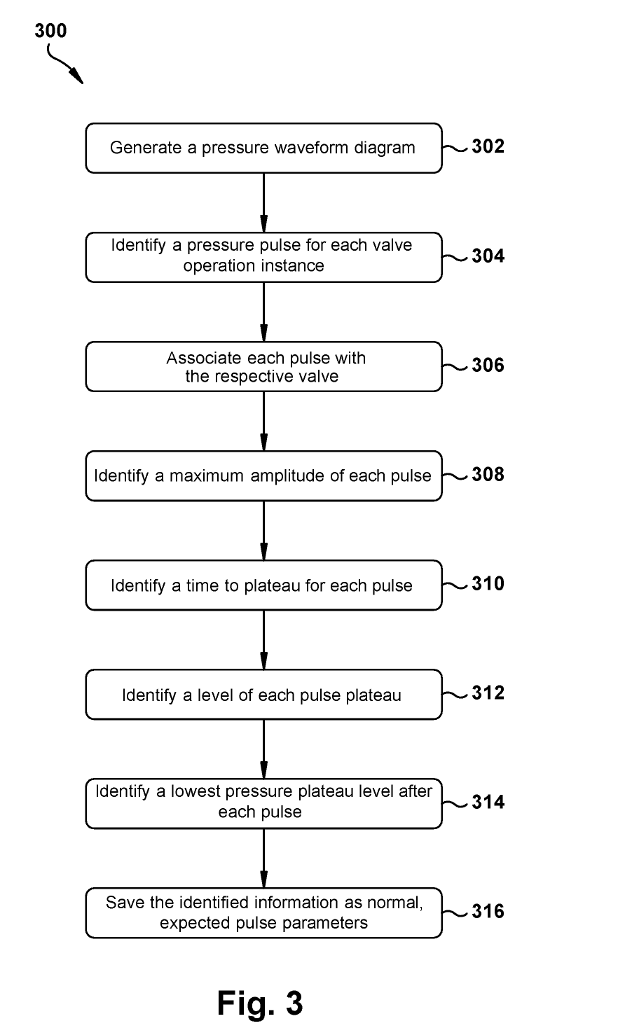

FIG. 2 is an exemplary pressure waveform diagram 200 of normal operation of a system. Operation of each of the valves is indicated by the waveforms 202, 204, and 206. In particular, waveform 202 indicates operation of the first valve, valve A, waveform 204 indicates operation of the purge valve, and waveform 206 indicates operation of valve B. Each pulse in the waveform 202 indicates operation of valve A, each pulse in the waveform 204 indicates operation of the purge valve, and each pulse in the waveform 206 indicates operation of valve B. The valve waveforms 202, 204, 206 show the expected valve positions; the actual valve positions are not measured, which is why pressure measurement is used to infer valve position. Waveform 208 illustrates the measured pressure during operation of these valves 202, 204, 206 in a reaction chamber, such as the reaction chamber 102 discussed with regard to FIG. 1 above. FIG. 2A is an enlarged view of a portion (a pressure pulse) of the exemplary pressure waveform of FIG. 2, illustrating the parameters of each pressure pulse of the pressure waveform that are identified in the method discussed below with regard to FIG. 3.

FIG. 3 is a flow diagram for an exemplary method of analyzing a pressure waveform diagram. For example, the flow diagram describes a method 300 of analyzing a pressure waveform diagram of normal valve operation, such as the waveform 200 illustrated by FIG. 2. As discussed above with regard to FIG. 2, the waveform 200 illustrates operation of valve A 202, the purge valve 204, and valve B 206 and the pressure waveform 208 corresponds to operation of these valves 202, 204, 206.

Once the waveform diagram is generated 302 from the pressure data, in block 304, a pressure pulse for each valve operation instance (valve opening and closing) is identified. At block 306, each identified pulse is associated with the respective valve whose operation instance is represented by the pulse. For example, the pulse can be identified with the respective valve by determining which valve was operating when the pressure pulse was recorded.

At block 308, a maximum amplitude Aₘₐₓ₋ₙₒᵣₘₐₗ of each pulse is identified. The maximum amplitude A is the maximum height reached by the pulse. At block 310, a time to plateau tₚₗₐₜₑₐᵤ₋ₙₒᵣₘₐₗ is identified for each pressure pulse. At block 312, the amplitude Aₚₗₐₜₑₐᵤ₋ₙₒᵣₘₐₗ of each pulse plateau is identified. At block 314, the lowest pressure plateau level Pₘᵢₙ₋ₙₒᵣₘₐₗ reached after each pulse is identified. At block 316, the information identified in the foregoing blocks is determined to be normal, expected pulse parameters and the information is saved in memory as said normal, expected parameters to which subsequent data will be compared. In another example, the identified pulse parameters are used to determine a range of acceptable values, such as an acceptable threshold value.

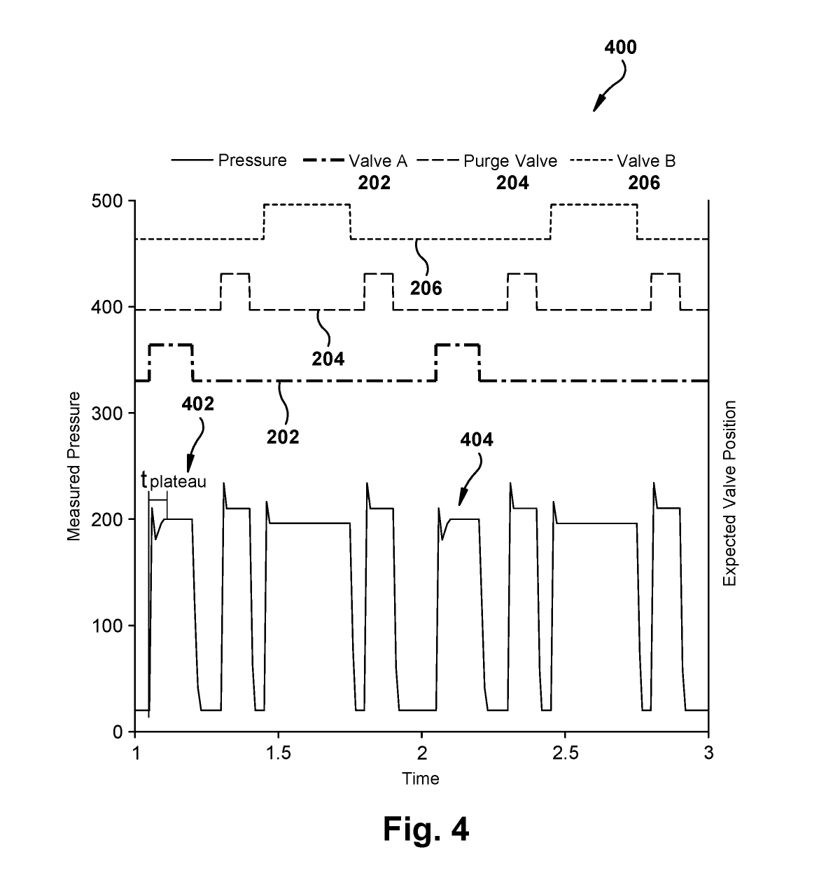

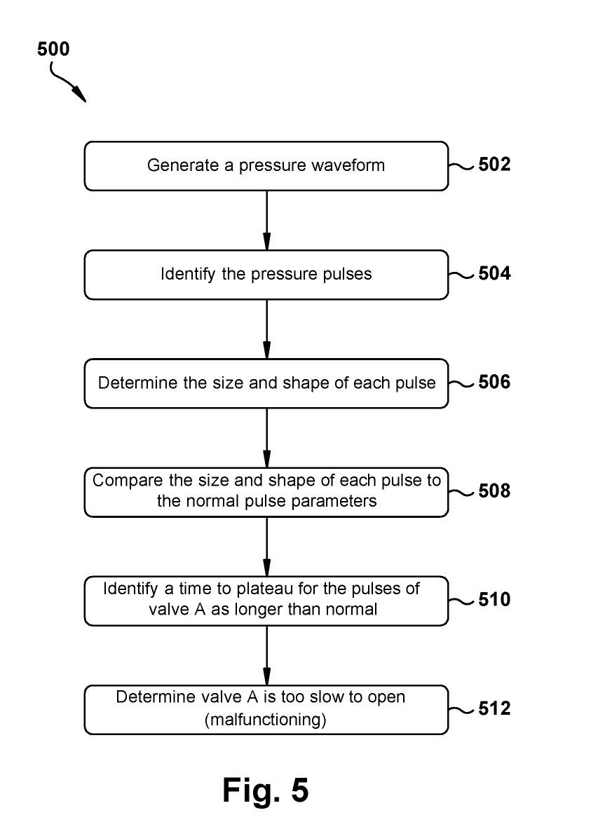

FIG. 4 is an exemplary pressure waveform diagram 400 of abnormal operation of a system. In particular, as will be discussed further below, the pressure waveform diagram 400 illustrates a valve A 202 which opens too slowly. The expected valve positions 202, 204, and 206 are the same as in FIG. 2. Analysis of this pressure waveform diagram 400 is discussed below with reference to FIG. 5.

FIG. 5 is a flow diagram for an exemplary method of analyzing a pressure waveform diagram 400 (FIG. 4) of abnormal operation of a system. At block 502, the pressure waveform diagram 400 is generated from measured pressure data. At block 504, the pulses in the pressure waveform are identified and associated with the respective operating valves. For example, pulses 402 and 404 are identified as corresponding to the pulses in the waveform 202 and, thus, representing pressure changes during operation of valve A.

At block 506, the size and shape of each pulse is determined. At block 508, the determined size and shape of each pulse is compared to the normal, expected pulse parameters. For example, the determined pulse parameters can be compared to the normal pulse parameters determined as discussed regarding FIGS. 2 and 3. During comparison of these pulse parameters, the time to plateau tₚₗₐₜₑₐᵤ for each pulse is compared to the expected time to plateau tₚₗₐₜₑₐᵤ₋ₙₒᵣₘₐₗ. At block 510, the times to plateau tₚₗₐₜₑₐᵤ for pulses 402 and 404 are identified as greater than the normal, expected time to plateau tₚₗₐₜₑₐᵤ₋ₙₒᵣₘₐₗ. Based on this identification, at block 512, valve A is determined to be a malfunctioning valve. In particular, valve A is determined to open too slowly.

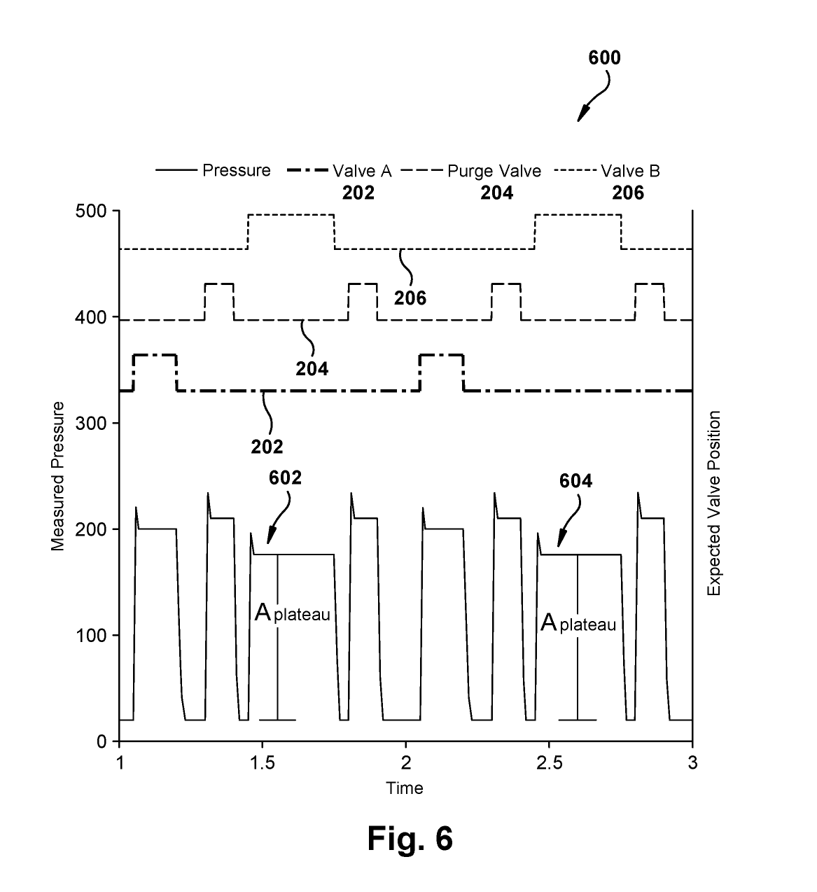

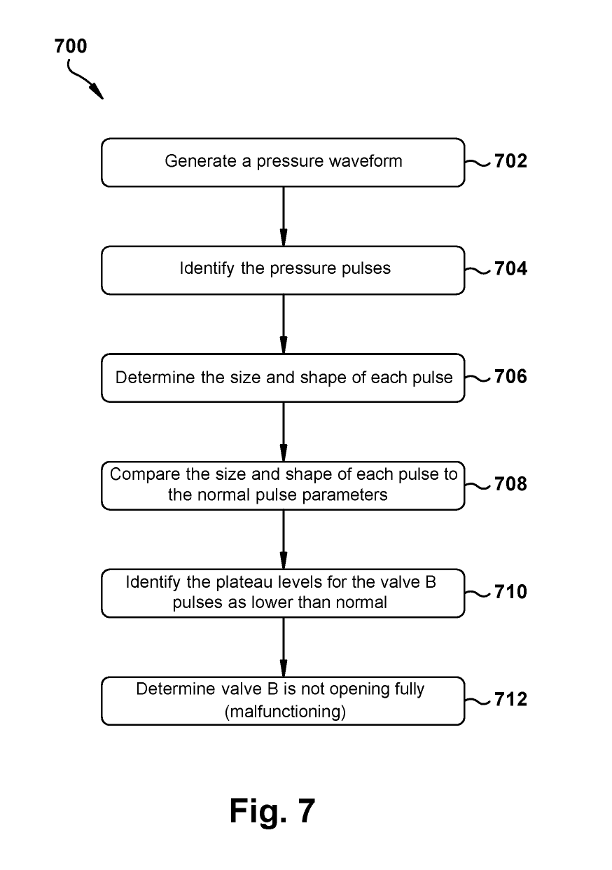

FIG. 6 is another exemplary pressure waveform diagram 600 of abnormal operation of a system. In particular, the pressure waveform diagram 600 illustrates that valve B fails to open fully. Analysis of this waveform diagram 600 is discussed below with regard to FIG. 7.

FIG. 7 is a flow diagram for another exemplary method 700 of analyzing a pressure waveform diagram 600 (FIG. 6) of abnormal operation of a system. At block 702, the pressure waveform diagram is generated from the measured pressure data. At block 704, the pulses in the pressure waveform are identified and associated with the respective operating valves. For example, pulses 602 and 604 are identified as corresponding to the pulses in the waveform 206 and, thus, representing pressure changes during operation of valve B.

At block 706, the size and shape of each pulse is determined. The size and shape include the maximum amplitude, the plateau amplitude, the pulse width, etc. At block 708, the determined size and shape of each pulse is compared to the normal, expected pulse parameters. For example, the determined pulse parameters can be compared to the normal pulse parameters determined as discussed regarding FIGS. 2 and 3. During comparison of these pulse parameters, the amplitude of each pulse plateau is compared to the normal, expected pulse plateau Aₚₗₐₜₑₐᵤ₋ₙₒᵣₘₐₗ. At block 710, the plateau amplitudes Aₚₗₐₜₑₐᵤ for pulses 602 and 604 are identified as lower than the normal, expected plateau amplitude Aₚₗₐₜₑₐᵤ₋ₙₒᵣₘₐₗ. At block 712, based on the identified lower than normal plateau amplitude, valve B is determined to be a malfunctioning valve. In particular, valve B is identified as failing to open fully.

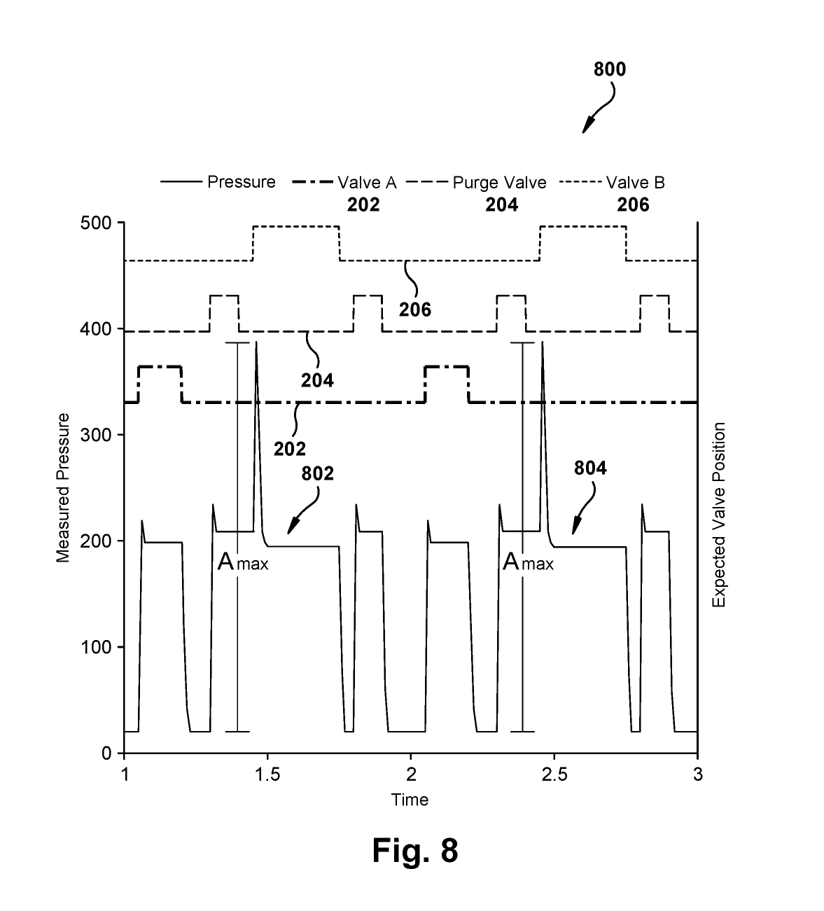

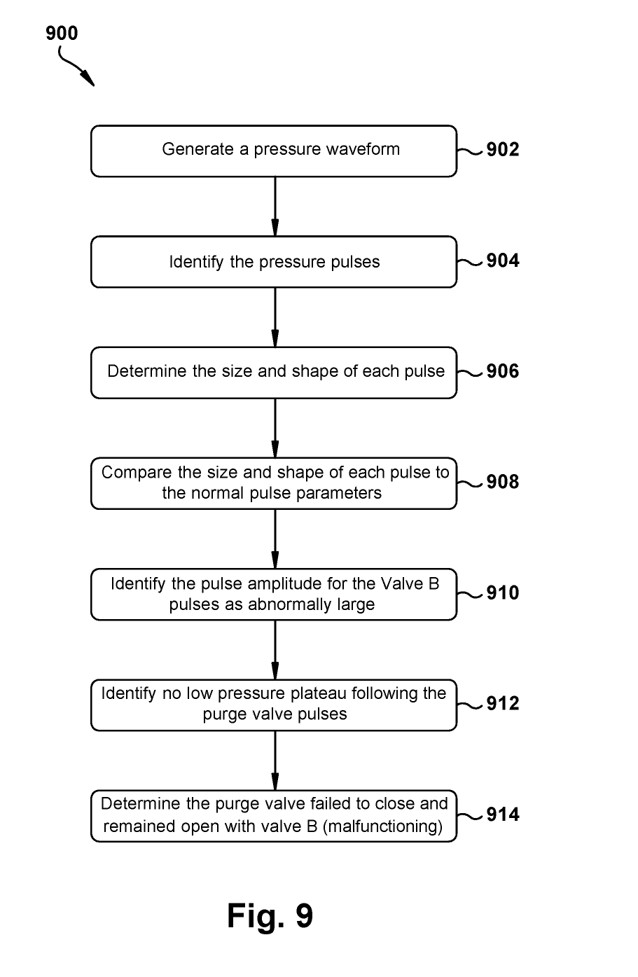

FIG. 8 is another exemplary pressure waveform diagram 800 of abnormal operation of a system. In particular, the pressure waveform diagram 800 illustrates the purge valve, represented by the waveform 204, as failing to close, or failing to close quickly enough. Analysis of this waveform diagram 800 is discussed below with regard to FIG. 9.

FIG. 9 is a flow diagram for another exemplary method 900 of analyzing a pressure waveform diagram 800 (FIG. 8) of abnormal operation of a system. At block 902, the pressure waveform diagram is generated from the measured pressure data. At block 904, the pulses in the pressure waveform are identified and associated with the respective operating valves. For example, pulses 802 and 804 are identified as corresponding to the pulses in waveform 204 and the pulses in waveform 206 and, thus, representing pressure changes during operation of the purge valve and valve B.

At block 906, the size and shape of each pulse is determined. The size and shape include the maximum amplitude, the plateau amplitude, the pulse width, etc. At block 908, the determined size and shape of each pulse is compared to the normal, expected pulse parameters. For example, the determined pulse parameters can be compared to the normal pulse parameters determined as discussed above regarding FIGS. 2 and 3.

During comparison of these pulse parameters, the maximum amplitude Aₘₐₓ of each pulse is compared to the normal, expected maximum pulse amplitude Aₘₐₓ₋ₙₒᵣₘₐₗ. At block 910, the maximum pulse amplitudes Aₘₐₓ for pulses 802 and 804 are identified as larger than the normal, expected maximum pulse amplitude Aₘₐₓ₋ₙₒᵣₘₐₗ. Also during comparison of the pulse parameters, the lowest pressure Pₘᵢₙ following each pulse is identified. At block 912, lack of a low pressure plateau following operation of the purge valve is identified. At block 914, based on the identified larger than normal maximum pulse amplitude of pulses 802 and 804 and the lack of a low pressure plateau following purge valve operation, the purge valve is identified as malfunctioning. In particular, the purge valve is identified as failing to close quickly enough and remaining open during the beginning of operation of valve B.

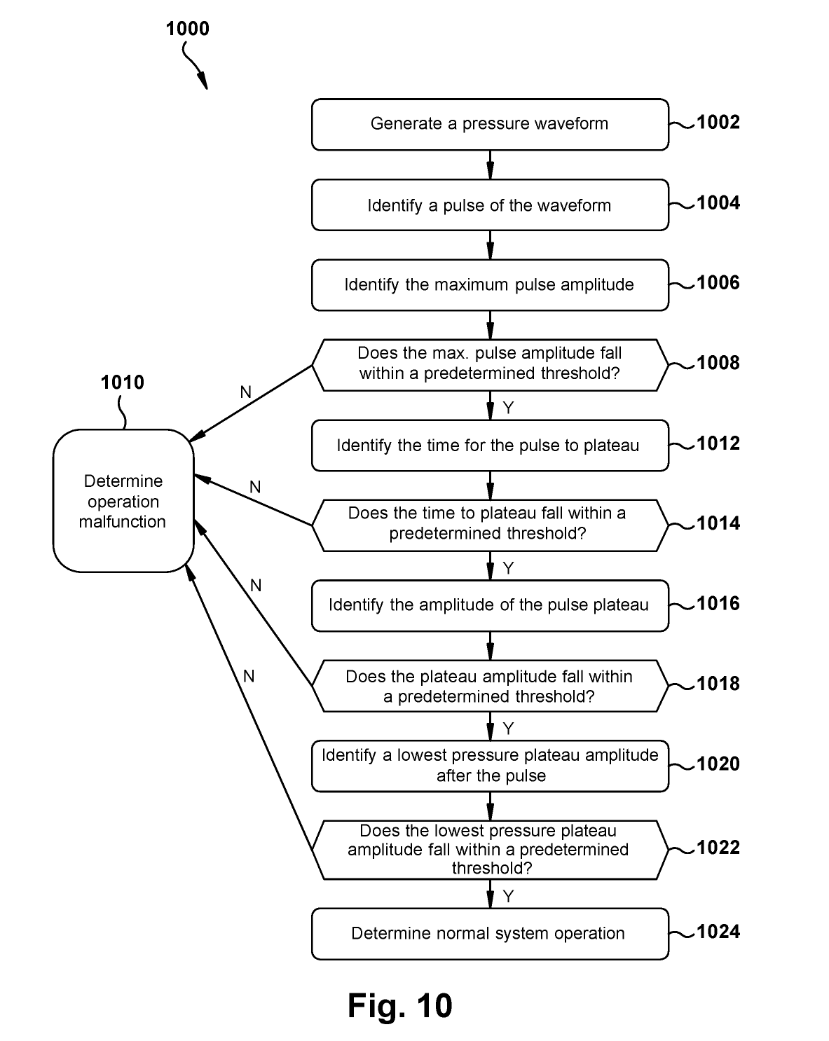

FIG. 10 is a flow diagram for an exemplary method 1000 of monitoring operation of a reaction chamber. For example, the method 1000 can be used to monitor operation of the system 100 described by FIG. 1. The pressure data gathered from a reaction chamber can be transmitted to a processor for analysis. The pressure data is analyzed to identify abnormal pressure changes within the reaction chamber and identify malfunctioning operation based on the identified abnormal pressure changes.

Based on pressure data gathered from the reaction chamber, at block 1002, a pressure waveform is generated, representing pressure changes within the reaction chamber during operation. At block 1004, a pulse of the waveform is identified. At block 1006, the maximum amplitude of the pulse is identified. At block 1008, the processor 121 (FIG. 1) can determine if the maximum amplitude of the pulse falls within a predetermined range of values. The predetermined range can be determined by analyzing a pressure waveform generated from pressure data gathered during known normal operation. In an example, the predetermined range can be a minimum threshold value and a maximum threshold value. In another example, the processor can determine if the maximum amplitude falls above or below a threshold value. If the maximum pulse amplitude does not fall within the predetermined range, for example, is below the minimum threshold value or above the maximum threshold value, at block 1010 operation malfunction is determined. If the maximum pulse amplitude does fall within the predetermined range, the method continues to block 1012.

At block 1012, the time for the pulse to plateau is determined. At block 1014, the processor 121 (FIG. 1) determines if the time for the pulse to plateau falls within the predetermined range. If the time for the pulse to plateau does not fall within the predetermined range, operation malfunction is determined at block 1010. If the time to plateau does fall within the predetermined range, the method continues at block 1016.

At block 1016, the amplitude of the pulse plateau is determined. At block 1018, the processor 121 (FIG. 1) determines if the amplitude of the pulse plateau falls within the predetermined range. If the amplitude of the pulse plateau does not fall within the predetermined range, operation malfunction is determined at block 1010. If the amplitude of the pulse plateau does fall within the predetermined range, the method continues at block 1020.

At block 1020, the amplitude of the lowest pressure plateau following each pressure pulse is determined. At block 1022, the processor determines if the amplitude of the lowest pressure plateau following each pressure pulse falls within the predetermined range. If the lowest pressure plateau following each pressure pulse does not fall within the predetermined range, operation malfunction is determined at block 1010. If the lowest pressure plateau following each pressure pulse does fall within the predetermined range, the method continues at block 1024. Upon identification of an operation malfunction, the processor 121 (FIG. 1) can instruct a user to repair and/or replace the hardware identified as malfunctioning.

Methods other than those described in FIGS. 3, 5, 7, 9, and 10 could also be used to determine whether or not the pressure waveform is abnormal. For example, a pattern matching algorithm that statistically compares the entire waveform to an exemplary waveform could be used. For this purpose, the exemplary waveform could be the average waveform for a set of processes known to be normal.

In view of the foregoing, embodiments of the invention provide a method for identifying malfunctioning valves in a reaction chamber. A technical effect is to enable early repair or replacement of the malfunctioning valves and prevent an increase in production of defective thin film samples.

As will be appreciated by one skilled in the art, aspects of the present invention may be embodied as a system, method, or computer program product. Accordingly, aspects of the present invention may take the form of an entirely hardware embodiment, an entirely software embodiment (including firmware, resident software, micro-code, etc.), or an embodiment combining software and hardware aspects that may all generally be referred to herein as a “service,” “circuit,” “circuitry,” “module,” and/or “system.” Furthermore, aspects of the present invention may take the form of a computer program product embodied in one or more computer readable medium(s) having computer readable program code embodied thereon.

Any combination of one or more tangible, non-transitory, computer readable medium(s) may be utilized. The computer readable medium may be a computer readable signal medium or a computer readable storage medium. A computer readable storage medium may be, for example, but not limited to, an electronic, magnetic, optical, electromagnetic, infrared, or semiconductor system, apparatus, or device, or any suitable combination of the foregoing. More specific examples (a non-exhaustive list) of the computer readable storage medium would include the following: an electrical connection having one or more wires, a portable computer diskette, a hard disk, a random access memory (RAM), a read-only memory (ROM), an erasable programmable read-only memory (EPROM or Flash memory), an optical fiber, a portable compact disc read-only memory (CD-ROM), an optical storage device, a magnetic storage device, or any suitable combination of the foregoing. In the context of this document, a computer readable storage medium may be any tangible medium that can contain, or store a program for use by or in connection with an instruction execution system, apparatus, or device.

Program code and/or executable instructions embodied on a computer readable medium may be transmitted using any appropriate medium, including but not limited to wireless, wireline, optical fiber cable, RF, etc., or any suitable combination of the foregoing.

Computer program code for carrying out operations for aspects of the present invention may be written in any combination of one or more programming languages, including an object oriented programming language such as Java, Smalltalk, C++ or the like and conventional procedural programming languages, such as the “C” programming language or similar programming languages. The program code may execute entirely on the user's computer (device), partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider).

Aspects of the present invention are described herein with reference to flowchart illustrations and/or block diagrams of methods, apparatus (systems) and computer program products according to embodiments of the invention. It will be understood that each block of the flowchart illustrations and/or block diagrams, and combinations of blocks in the flowchart illustrations and/or block diagrams, can be implemented by computer program instructions. These computer program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks.

These computer program instructions may also be stored in a computer readable medium that can direct a computer, other programmable data processing apparatus, or other devices to function in a particular manner, such that the instructions stored in the computer readable medium produce an article of manufacture including instructions which implement the function/act specified in the flowchart and/or block diagram block or blocks.

The computer program instructions may also be loaded onto a computer, other programmable data processing apparatus, or other devices to cause a series of operational steps to be performed on the computer, other programmable apparatus or other devices to produce a computer implemented process such that the instructions which execute on the computer or other programmable apparatus provide processes for implementing the functions/acts specified in the flowchart and/or block diagram block or blocks.

This written description uses examples to disclose the invention, including the best mode, and also to enable any person skilled in the art to practice the invention, including making and using any devices or systems and performing any incorporated methods. The patentable scope of the invention is defined by the claims, and may include other examples that occur to those skilled in the art. Such other examples are intended to be within the scope of the claims if they have structural elements that do not differ from the literal language of the claims, or if they include equivalent structural elements with insubstantial differences from the literal language of the claims.

What is claimed is:

1. A system for monitoring valve function, the system comprising:
a reaction chamber for receiving a substrate;
a plurality of gas inlets for introducing a plurality of gases to the reaction chamber;
a plurality of valves, a valve coupled to each gas inlet to control flow of gas through each gas inlet to the reaction chamber;
a high-speed pressure gauge coupled to the reaction chamber to monitor pressure within the reaction chamber; and
a processor coupled to the pressure gauge configured to:
receive pressure data from the pressure gauge;
generate a plurality of pressure readings to identify pressure changes within the reaction chamber due to operation of the plurality of valves;
compare the generated pressure readings to a reference pressure reading;
analyze the generated pressure readings to identify a change in pressure that differs from the reference pressure reading;
identify which valve was operating during the change in pressure; and
diagnose the identified valve as a malfunctioning valve.

2. The system of claim 1, wherein the pressure readings comprise a pressure waveform, and the processor configured to analyze the generated pressure readings comprises:
determining a size and shape of each pressure pulse within the pressure waveform to identify parameters of each pressure pulse;
determining if the identified parameters fall within a predetermined range; and
identifying an abnormal pressure change when the identified parameters are not within the predetermined range.

3. The system of claim 2, wherein determining the size and shape of each pressure pulse comprises at least one of determining a maximum amplitude of each pressure pulse of the waveform, determining a time to plateau for each pressure pulse, identifying a plateau amplitude for each pressure pulse, and identifying a lowest pressure amplitude following each pressure pulse.

4. The system of claim 3, wherein when the time to plateau for a pressure pulse is greater than the predetermined range, a valve is identified as opening too slowly.

5. The system of claim 3, wherein when the maximum amplitude of a pressure pulse is greater than the predetermined range, a valve is identified as failing to close.

6. The system of claim 1, wherein the reference pressure reading comprises a pressure reading generated from pressure data gathered during known normal operation.

7. A method for monitoring operation of a reaction chamber for malfunctions, the reaction chamber comprising a high-speed pressure gauge coupled therewith to collect pressure data within the reaction chamber during operation of the reaction chamber, the method comprising:
receiving, in a processor, the pressure data from the pressure gauge;
generating a plurality of pressure readings from the pressure data identifying pressure changes within the reaction chamber during operation;
analyzing the plurality of pressure readings to identify an abnormal pressure change; and
determining an operating malfunction when the abnormal pressure change is identified.

8. The method of claim 7, wherein the pressure gauge is configured to record pressure data at least one hundred times per second.

9. The method of claim 7, wherein the plurality of pressure readings comprise a waveform diagram and wherein analyzing the plurality of pressure readings comprises:
determining a size and shape of each pressure pulse of the waveform; and
comparing the size and shape of each pressure pulse to a size and shape of a waveform generated from pressure data gathered under known normal operation.

10. The method of claim 7, further comprising identifying a type of operating malfunction based on the plurality of pressure readings.

11. The method of claim 7, wherein the reaction chamber comprises a plurality of gas inlets for introducing gases to the reaction chamber, each gas inlet comprising a valve for controlling gas flow through the gas inlet into the reaction chamber.

12. The method of claim 11, wherein an operating malfunction comprises malfunction of a valve.

13. The method of claim 12, wherein malfunction of the valve comprises at least one of a valve incompletely opening/closing, the valve too slow to open/close, the valve does not open, and multiple valves open simultaneously.

14. The method of claim 7, further comprising identifying a malfunctioning piece of hardware and instructing a user to repair or replace the malfunctioning piece of hardware.

15. The method of claim 7, wherein analyzing the plurality of pressure readings comprises at least one of identifying a maximum amplitude of each pressure pulse of a waveform diagram, determining a time to plateau for each pressure pulse, identifying a plateau amplitude for each pressure pulse, and identifying a lowest pressure amplitude following each pressure pulse.

16. A tangible, non-transitory, computer-readable storage medium comprising instructions to direct a processor to monitor operation of a reaction chamber for malfunctions, the reaction chamber comprising a high-speed pressure gauge coupled therewith to collect pressure data within the reaction chamber during operation of the reaction chamber, the instructions directing the processor to:
receive the pressure data from the pressure gauge;
generate a plurality of pressure readings from the pressure data identifying pressure changes within the reaction chamber during operation;
analyze the plurality of pressure readings to identify an abnormal pressure change; and
determining an operating malfunction when the abnormal pressure change is identified.

17. The storage medium of claim 16, wherein analyzing the plurality of pressure readings comprises:
determining a size and shape of each pressure pulse within a waveform diagram to identify parameters of each pressure pulse;
determining if the identified parameters fall within a predetermined range; and
identifying an abnormal pressure change when the identified parameters are not within the predetermined range.

18. The storage medium of claim 17, wherein the predetermined range is determined based on analysis of a waveform diagram generated from pressure data gathered during known normal operation.

19. The storage medium of claim 17, wherein determining the size and shape of each pressure pulse comprises at least one of determining a maximum amplitude of each pressure pulse of the waveform, determining a time to plateau for each pressure pulse, identifying a plateau amplitude for each pressure pulse, and identifying a lowest pressure amplitude following each pressure pulse.

20. The storage medium of claim 16, further comprising identifying a type of operation malfunction based on the plurality of pressure readings.
